(19) United States
(12) Patent Application Publication
(10) Pub. No.: US 2011/0047388 A1
(43) Pub. Date: Feb. 24, 2011

(54) METHOD AND APPARATUS FOR REMOTELY CONTROLLING ACCESS TO PORNOGRAPHIC CONTENT OF AN IMAGE

(75) Inventors: Tae-suh PARK, Seongnam-si (KR); Ui-hyeon HWANG, Yongin-si (KR); Seung-ji YANG, Seongnam-si (KR); Doo-yeon LEE, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/688,162

(22) Filed: Jan. 15, 2010

(30) Foreign Application Priority Data
Aug. 24, 2009 (KR) 10-2009-0078174
Nov. 17, 2009 (KR) 10-2009-0110921

(51) Int. Cl. G06F 12/14; G06K 9/62; H04L 9/08; G06F 15/16

(52) U.S. Cl. 713/189; 382/224; 726/3; 380/283; 709/206

(57) ABSTRACT

A method and apparatus are provided for remotely controlling access to pornographic content of an image in a first device, the method including acquiring content of the image, determining whether the content of the image is pornographic by analyzing at least one image frame constituting the contents of the image, blocking access to the content of the image when the content is determined to be pornographic, extracting at least one representative problematic image frame from the content of the image; transmitting the at least one representative problematic image frame to a second device; receiving control commands from the second device and controlling access to the content of the image blocked in the first device, based on the control commands.

### CROSS-REFERENCE TO RELATED PATENT APPLICATION

This application claims the benefits of priority from Korean Patent Application No. 10-2009-0110921, filed on Nov. 17, 2009 and Korean Patent Application No. 10-2009-0078174, filed on Aug. 24, 2009, in the Korean Intellectual Property Office, the disclosures of which are incorporated herein in their entirety by reference.

### BACKGROUND

1. Field

Apparatuses and methods consistent with described embodiments relate to remotely controlling access to pornographic content of an image in a playback device.

2. Description of the Related Art

As wide-band Internet and cable broadcasting have become widely used, means for distributing inappropriate images, including pornographic images, has become increasingly varied, and thus, an underage person may be exposed to pornography or other inappropriate content at an early age. In particular, due to an increase in dual-income families, a child who is underage often uses a computer or watches television (TV) alone, and mobile devices that play back images, such as portable media players (PMPs), mobile phones, and netbooks, have become widely used. Thus, the possibility that children may view pornography when by themselves without any parental supervision, has increased, and it has gradually become more difficult for parents to block access to pornography.

Social demands for protecting children from pornography have gradually increased, and tougher laws to protect children from exposure to pornography are desired. In addition, it is difficult to pass laws protecting children from pornography due to concerns that laws regulating access to content intrude upon individual rights and liberties. Thus, the United States Congress has passed the Child Safe Viewing Act (CSVA) to allow technical blocking methods by which the right of parental choice is guaranteed. The blocking methods may be used in various apparatuses that are not dependent on a conventional rating system, such as TVs and digital video recorders (DVRs), which are inspected by the Federal Communications Commission (FCC).

Due to these social demands for blocking children from viewing pornography, there is an unmet need for technical solutions for blocking pornographic content.

### SUMMARY OF THE INVENTION

One or more exemplary embodiments provide a method and apparatus for remotely controlling access to pornographic content of image and minimizing the occurrence of a false alarm while maintaining the convenience of an automatic pornography detection system, so that an immediate parental response may be taken to block a child's access to pornographic content.

Exemplary embodiments also provide a method and apparatus for remotely controlling access to pornographic content in at least one image by initially preventing a child's ability to playback and distribute pornographic content by automatically detecting pornographic content when a child has acquired pornography via a mobile device, which can prevent pornographic user-created contents (UCC) from being thoughtlessly distributed and exposed to an underage person.

According to one exemplary embodiment, there is provided a method of remotely controlling access to pornographic content of an image in a first device, including acquiring content of the image from an external source; determining whether the content of the image is pornographic by analyzing at least one image frame constituting the content of the image; blocking access to the content of the image when the content is determined to be pornographic; copying at least one representative problematic image frame from the content of the image; transmitting the at least one representative problematic image frame to a second device; receiving control commands from the second device; and controlling access to the content of the image blocked in the first device, based on the control commands.

According to another exemplary embodiment, there is provided an apparatus for remotely controlling access to pornographic content of an image in a first device, the apparatus including an image content acquiring unit by which the first device receives the content of the image from an external source; a pornography determining unit which determines whether the content of the image are pornographic by analyzing a plurality of image frames constituting the content of the image; a pornography processing unit which blocks access to the content of the image when the content is determined to be pornographic; a pornography sample acquiring unit which extracts at least one representative problematic image frame from the content of the image; and a network interface unit which transmits the at least one representative problematic image to a second device and receives control commands from the second device, wherein the pornography processing unit controls access to the content of the image blocked in the first device, based on the control commands.

According to another exemplary embodiment, there is provided a computer program product stored on a computer readable recording medium having recorded thereon a program for executing, on a computer system, a method of remotely controlling access to pornographic content of an image.

### BRIEF DESCRIPTION OF THE DRAWINGS

The above and/or other aspects will become more apparent from the following description of exemplary embodiments taken in conjunction with the attached drawings, in which:

FIG. 1 is a flowchart illustrating a method of remotely controlling access to pornographic content of an image, according to an exemplary embodiment;

FIG. 2 shows a series of operations that are performed between a child who has acquired pornographic content via a mobile phone and a parent who has control over the child's access to the pornographic content, according to an exemplary embodiment;

FIG. 3 is a flowchart illustrating a method of remotely controlling access to pornographic content, according to another exemplary embodiment.

FIGS. 4A and 4B show processes for respectively blocking and allowing access to content of an image that is determined to be pornographic by an automatic detection function, according to an exemplary embodiment;

FIG. 5 is a functional block diagram of an apparatus for remotely controlling access to pornographic content of an image, according to an exemplary embodiment; and

FIG. 6 is a functional block diagram of an apparatus for remotely controlling access to pornographic content of an image, according to another exemplary embodiment.

### DETAILED DESCRIPTION

Reference will now be made in detail to the exemplary embodiments of the invention with reference to the attached drawings. The following detailed description includes specific details in order to provide a thorough understanding of the exemplary embodiments. However, it will be apparent to those skilled in the art that the exemplary embodiments may be practiced without such specific details.

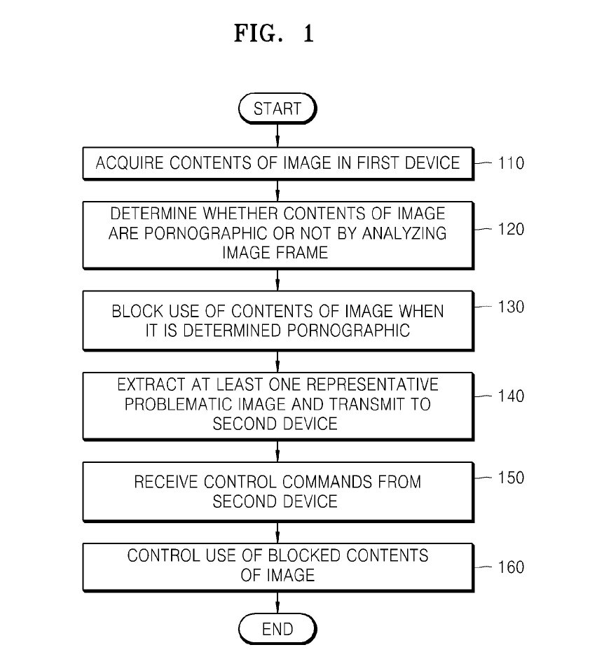

FIG. 1 is a flowchart illustrating a method of remotely controlling access to pornographic content of an image, according to an exemplary embodiment.

In a conventional method of blocking pornographic content of an image from being displayed by a personal computer (PC) in a child's room, when it is determined that content of the image is pornographic, based on color and contour information, viewing of the pornographic content is allowed only when a user of the PC inputs an encryption key. Another conventional alternative displays the content being displayed on a monitor of the PC on a television (TV) disposed in a living room, perhaps as a picture-in-picture (PIP), so that a parent may monitor the content being viewed by his or her child.

However, it is not realistic for a parent to continuously monitor a child's PC or a TV in remote locations 24 hours a day, since the parent's time and attention are required elsewhere. Meanwhile, when a function of detecting pornography is automated, a parent does not need to monitor the child's PC or the TV at all times. However, due to limitations of algorithms for recognizing pornography, a false alarm may inevitably be generated, where content of an image is blocked even though the content is not pornographic. When false alarms are constantly generated in a device, a user may not be able to view a non-pornographic image, which is an inherent function of the device. For example, while a user of a child's PC or TV monitor is viewing a general cosmetic advertisement, a device that identifies pornographic content by sensing a large amount of skin colors may determine that the advertisement is pornographic, and then the PC or TV monitor may suddenly block the image and display a message indicating that a password has to be input in order to display the content. If such false alarm experiences occur frequently, the automated function of detecting pornography disturbs normal viewing, and thus, in spite of convenience offered by the automated function, the device may not be used by consumers.

Thus, exemplary embodiments propose a method of remotely controlling use of pornographic content of an image by minimizing the occurrence of a false alarm while maintaining the convenience of an automatic pornographic content detection system, so that an immediate parental response may be taken to block access to the pornographic content.

In addition, since most small-sized portable devices include a digital camera or a camcorder module for capturing a high-definition moving image as well as a still image (e.g., a photograph), the number of pornographic images that are made by ordinary people, as well as the number of pornographic images that are commercially and professionally made, have rapidly increased and spread via Internet, which is considered a social problem. That is, an underage person may be exposed to pornography at an early age, and may easily make and distribute pornography themselves.

However, a conventional method of blocking pornographic content of an image focuses on preventing playback of pornography only. In the past, most pornographic images were commercially and professionally made, and ordinarily, people only viewed pornographic images. Thus, it was only necessary to prevent playback of pornographic images to an underage person. However, recently, production of pornographic user-created contents (UCC) is increasing rapidly compared to commercial and professional production of pornographic images. Since these pornographic UCC may be spread to underage people via mobile devices, there is a need to prevent pornography from being made and distributed by a user of a mobile device.

Referring to FIG. 1, in one exemplary embodiment, the method of remotely controlling access to pornographic content of an image includes acquiring content of image from an external source in a first device (Operation 110); determining whether the content of the image is pornographic by analyzing at least one image frame constituting the content of the image (Operation 120); blocking access to the content of the image when it is determined that the content of the image is pornographic (130); copying at least one representative problematic image frame from the blocked content of the image and transmitting the copied representative problematic image frame to a second device (Operation 140); receiving control commands from the second device (Operation 150); and controlling the access to the content of the image blocked in the first device, based on the received control commands (Operation 160).

In Operation 110, the content of the image is acquired. For example, a user photographs himself or herself using the first device, for example, a mobile phone including a camera. The first device for acquiring the content of the image may be any image-related consumer electronic (CE) product for capturing a still image or a moving image, such as a digital camera, a mobile phone, a camcorder, a netbook computer or a portable media player (PMP). The acquiring of the content of the image includes copying and moving content of an image already captured as an image or a moving image from an external device through a wired/wireless network, capturing an image of a user, or capturing a moving image.

In Operation 120, it is determined whether the content of the image is pornographic. Operation 120 may be performed simultaneously with Operation 110 in real time.

There may be a variety of algorithms for determining whether content of an image is pornographic. In one exemplary embodiment, with respect to content of a moving image, a moving area is detected from a plurality of moving image frames, and skin estimation areas estimated to represent human skin are detected based on saturation values of pixels included in each of the moving image frames, and it is then determined whether the content of the moving image is pornographic based on the ratio of the skin estimation areas to the moving area.

More specifically, the moving area is detected from the plurality of moving image frames, which constitute the content of the moving image. In this exemplary embodiment, the moving area may be detected based on an image difference that is formed by comparing the plurality of moving image frames and at least one moving image frame that is adjacent to the plurality of moving image frames. For example, when a person moves against a fixed background in the moving image frames, an area in which the person had moved may be detected as the moving area of the moving image frames. The exemplary embodiments are not limited to this method of detecting a moving area, and any of various methods of detecting a moving area, known or not yet discovered, may be used.

Once the moving area is calculated, the skin estimation areas estimated to represent human skin are detected based on the saturation values of the pixels included in each of the moving image frames. It is determined whether the content of the moving image is pornographic based on the ratio of the skin estimation areas to the moving area of each of the moving image frames. The ratio of the skin estimation areas to the moving area of each of the moving image frames is used in order to reduce the risk of erroneously identifying the content of the moving image frame as pornographic when it is not. For example, in related arts, even when a moving image frame in which a person whose skin is excessively exposed exists, when the person takes up a relatively large portion of the frame and the ratio of the person to the moving image frame is high, the moving image frame may be determined to be pornographic. However, when the person takes up a relatively small portion of the frame and the ratio of the person to the moving image frame is low, the moving image frame may be determined not to be pornographic. However, even if the size of the person is small and thus the ratio of the person to the entire scene of the moving image frame is low, by using the ratio of the skin estimation areas to the moving area of each of the moving image frames, the ratio of the skin estimation areas to the moving area of each of the moving image frames may be high, and thus the moving image frame may be determined to be pornographic.

Referring back to FIG. 1, in Operation 130, when it is determined that the content of the image is pornographic, the access to the content of the image is first blocked. In this case, the access to the content of the image may be blocked by encrypting the content of the image or inactivating the image itself through a file system such as a file allocation table (FAT) or new technology file system (NTFS).

In operation 140, at least one representative problematic image frame is copied from the content of the image that was determined to be pornographic according to the result of determination operation 120. The representative problematic image frame then is transmitted to the second device. The second device may be a parent-controlled device that has authority to control the first device. For example, the first device may be any of a TV, a PC, a portable media player (PMP), etc., and the second device may be a mobile phone or netbook with the ability to control the first device.

In one exemplary embodiment, the representative problematic image frame transmitted to the second device is an image frame having a relatively high degree of lewdness from among problematic image frames having a degree of lewdness that exceeds a predetermined reference value of lewdness. The degree of lewdness may be determined based on the ratio of the human skin estimation areas to the moving area of each of the image frames. In other words, when the content of the image that is being played back is determined to be pornographic as a result of real-time detection, at least one representative problematic image frame having the highest degree of nudity is copied from the plurality of image frames that constitute the contents of the image and, and the representative problematic image frame is then transmitted to the second device.

Thus, an algorithm is performed for a predetermined amount of time for determining whether image frames of the content of the image are pornographic, and the image frames having a degree of lewdness greater than a predetermined reference value are determined as being pornographic. A representative problematic image frame having the highest degree of lewdness is selected from among the image frames and transmitted to the parental device (second device). The representative problematic image frame may be transmitted as an attached image via a multimedia message service (MMS) or a mobile e-mail, and may be transmitted via any protocol or communication channel through which image file transmission is supported. As such, when a child is viewing a image that is suspected to be pornographic, a parent at a remote location may receive the representative problematic image frame and may check whether the child is viewing pornography, thereby performing real-time remote monitoring. The method of remotely controlling access to pornographic content of an image, as illustrated in FIG. 1, includes an operation of controlling a child's image playback device that a child is viewing by using a parent-controlled device that may check a representative problematic pornographic image frame.

Thus, in Operation 150, control commands are received from the second device possessed by a parent, such as a mobile phone or a netbook, and in Operation 160, playback of content of the image that is being played back by the first device may be allowed or denied, based on the received control commands.

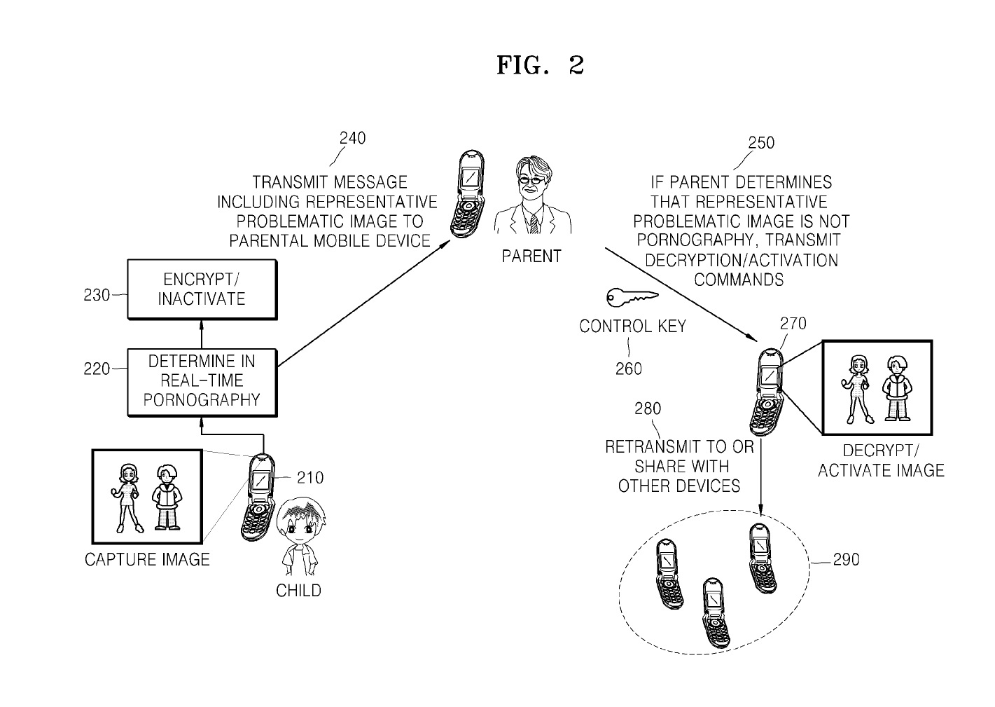

FIG. 2 shows a series of operations that may be performed between a child who has acquired pornography via a mobile phone and a parent who has control over the child's access to content on the mobile phone, according to an exemplary embodiment.

Referring to FIG. 2, when the child captures content of an image that is suspected to be pornographic by using a camera included in the mobile phone (210), a real-time determination is made as to whether the content of the image is pornographic (220). If it is determined that the content of the image is pornographic, the content of the image is encrypted or inactivated (230). Then, a message attached with a representative problematic image frame is transmitted to a parental mobile device (240) controlled by the parent.

A parent having the parent-controlled mobile device and at a remote location may check the representative problematic image frame, and the parent may determine whether the representative problematic image frame is pornographic and thus not proper for the child. If the parent determines that the representative problematic image frame is not problematic, control commands allowing the child to access the content of the image are transmitted to the child's mobile device (250). In one exemplary embodiment, a control key, such as a decryption key or an activation key, is transmitted (260). When the child's mobile device receives the control commands and the control key from the parent-controlled mobile device, the content of the image, which were encrypted or inactivated, are decrypted or reactivated using the control key (270). In addition, the content of the image may be transmitted to or shared with other devices 290 according to the control commands (280).

According to another exemplary embodiment, when an event indicating that a device controlled by a child in which a pornography detector is installed has acquired a pornographic image, content of the image is encrypted or inactivated, a message including a plurality of representative problematic image frames copied from the content of the image is transmitted to a parent-controlled mobile phone via a multimedia messaging service (MMS) or e-mail. A parent may be allowed to determine a degree of lewdness and to decide upon a response method, and then the chosen response method is transmitted to the child's device so that playback of the content of the moving image may be blocked or allowed.

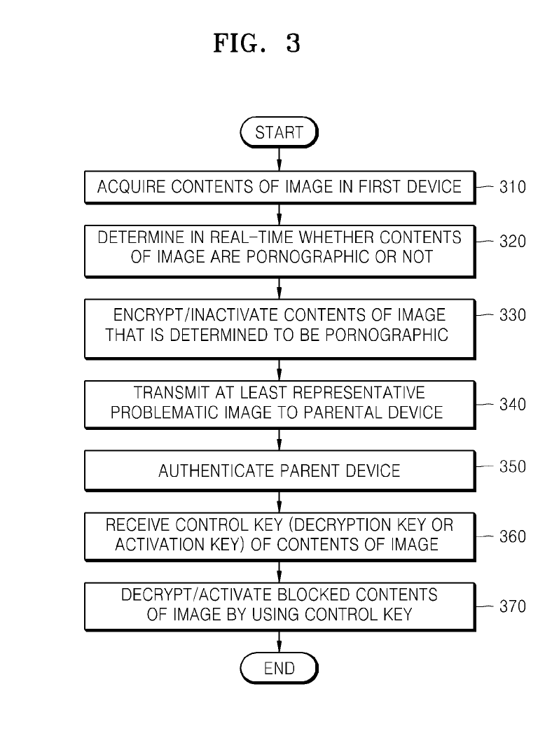

The method of remotely controlling access to pornographic content of an image may further include an authenticating operation for determining whether the control commands received at a child's device are transmitted from a parent-controlled device with appropriate authority, as shown in FIG. 3. FIG. 3 is a flowchart illustrating a method of remotely controlling access to pornographic content, according to another exemplary embodiment.

Referring to FIG. 3, the method includes acquiring content of an image from an external source (310); determining in real-time whether the acquired content of the image is pornographic (320); encrypting or inactivating the content of the image when it is determined that the content of the image is pornographic (330); extracting at least one representative problematic image frame from the content of the image and transmitting the at least one representative problematic image frame to a parent-controlled device (340); authenticating whether the parent-controlled device transmitting control commands has authority when the control commands are received from the parental device (350); receiving a control key such as a decryption key or an activation key required for access to the blocked content of the image (360); and decrypting or reactivating the content of the image by using the received control key (370). Thus, the content of the image may be normally viewed, or copied and moved to another device.

In this exemplary embodiment, controlling the content of the image may include at least one controlling operation from among playback, storing, copying, moving, deleting and editing operations on the content of the image. Access to the content of the image may be controlled according to a controlling degree of entire allowance, partial allowance or entire disallowance when the contents of the image are used. In addition, the access to the content of the image may be controlled based on a point of time when the content of the image is capable of being used, a length and duration of the content of the image, an amount of the content of the image, image quality or a sound quality of the content of the image, and a medium for transmitting the content of the image.

In one exemplary embodiment, when the parent determines that the content of the image is pornographic, the parent does not transmit the control key, and transmits control commands that do not allow a child to playback or distribute the content of the image. Thus, the parent may control the child's device so as not to allow the content of the image to be played back, copied or moved.

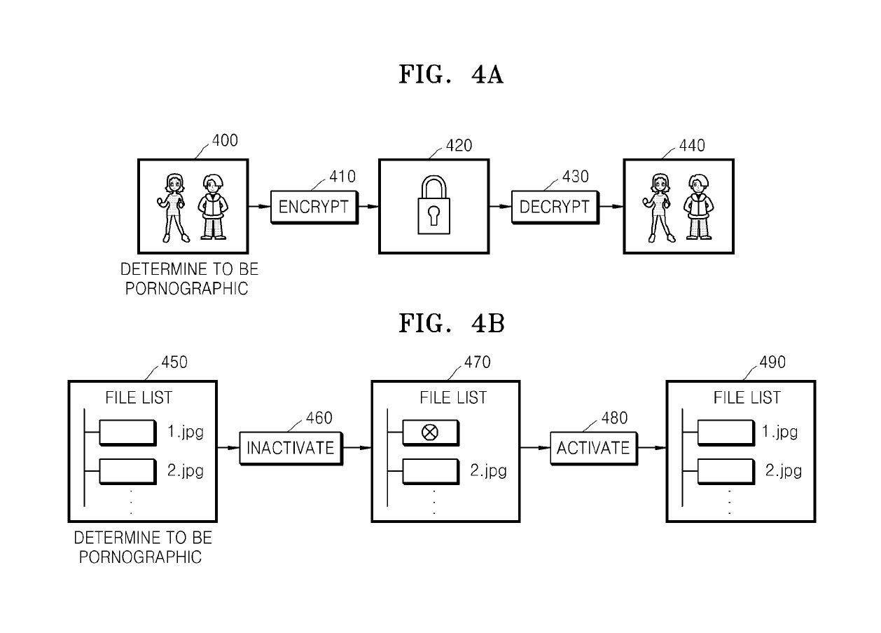

FIGS. 4A and 4B show a process for blocking and allowing access to content of an image that is determined to be pornographic by an automatic detection function, according to an exemplary embodiment. That is, FIG. 4A depicts where the content of the image is encrypted and decrypted when the use of the content of the image is respectively blocked and allowed. FIG. 4B shows a case where the content of the image is inactivated and reactivated when the use of the content of the image is respectively blocked and allowed.

In a further explanation of an encryption/decryption operation, in FIG. 4A, when it is determined that the content of the image is pornographic (400), an encryption operation is performed (410), and the content of the image is encrypted so that the content of the image is not allowed to be accessed (420). Then, when control commands for allowing a user to access the content of the image is transmitted from the parent-controlled device, a decryption operation is performed (430), and the content of the image is converted into a normal state.

In FIG. 4B, when it is determined that the content of the image is pornographic (450), the image is inactivated through a file system (e.g., file allocation table (FAT) or new technology file system (NTFS)) (460), and thus the image may be hidden from the user or blocked so that the user may not select the image (470). Then, when control commands for allowing the user to access the content of the image are received from a parent, an activation operation is performed (480), and the content of the image is converted into a normal state (490).

In order to maximize the effect of the system for blocking access to pornographic content, once it is determined that pornography has been acquired by a child's device, but before problematic images are transmitted to a parental mobile device, a warning message is displayed on a monitor of the child's device.

For example, if the child captures an image and a real-time nudity detector analyzes the content of the image and determines that content of the image is pornographic, a warning message is displayed on a child's device indicating that “The current image is determined to be pornography. If you do not stop using it, a message will be transmitted to your parents after 10 seconds.” The warning message may be displayed on a monitor of the child's device in the form of subtitle for a predetermined amount of time (e.g., 10 seconds) before an MMS message is transmitted to a parent's mobile phone.

Thus, a parent who is at a remote location away from the child may receive the representative problematic image frames from the content of the image that the child has acquired via her or his mobile phone, and the parent may determine whether the representative problematic image frames are pornographic and whether the child's access to the content should be restricted.

Furthermore, before the child's device is controlled by the parent-controlled device, mutual authentication may be performed between the devices. In other words, an operation of mutually authenticating whether the second device, or parent-controlled device, which transmits control commands, is an authenticated device that has been already registered in the first device, or child-controlled device, may be additionally performed. For example, only when it has been authenticated that the control commands are commands transmitted by a parent-controlled mobile phone that has been already registered in the child's PMP, based on a sender identifier (ID) or a password, may playback of the content of the image be controlled.

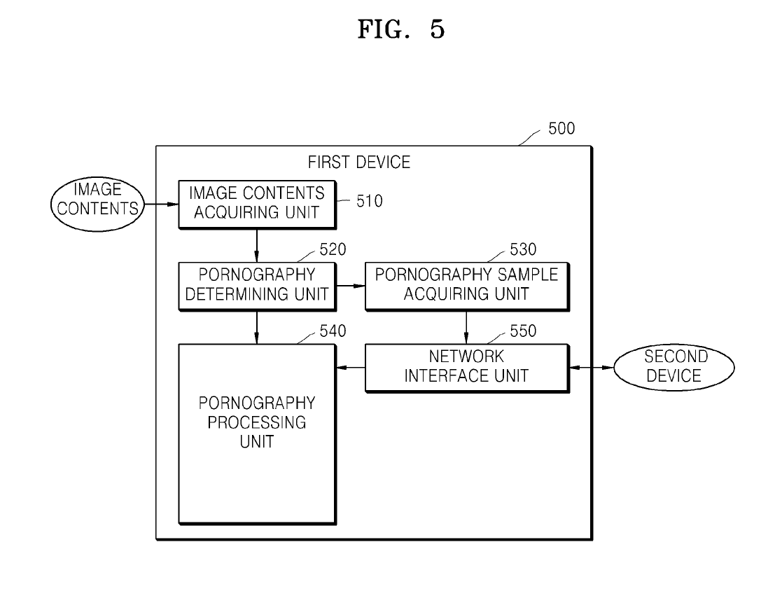

FIG. 5 is a functional block diagram of an apparatus 500 for remotely controlling access to pornographic content of an image, according to an exemplary embodiment.

Referring to FIG. 5, the apparatus 500 for controlling pornographic content of an image in a first device includes an image content acquiring unit 510 by which the first device receives the content of the image from an external source, a pornography determining unit 520 that determines whether the content of the image is pornographic by analyzing a plurality of image frames that constitute the content of the image, a pornography processing unit 540 that blocks the content of the image when it is determined that the content of the image is pornographic, a pornography sample acquiring unit 530 that copies at least one representative problematic image frame from the content of the image, and a network interface unit 550 that transmits the representative problematic image frame to a second device and receives control commands from the second device regarding the contents of the image.

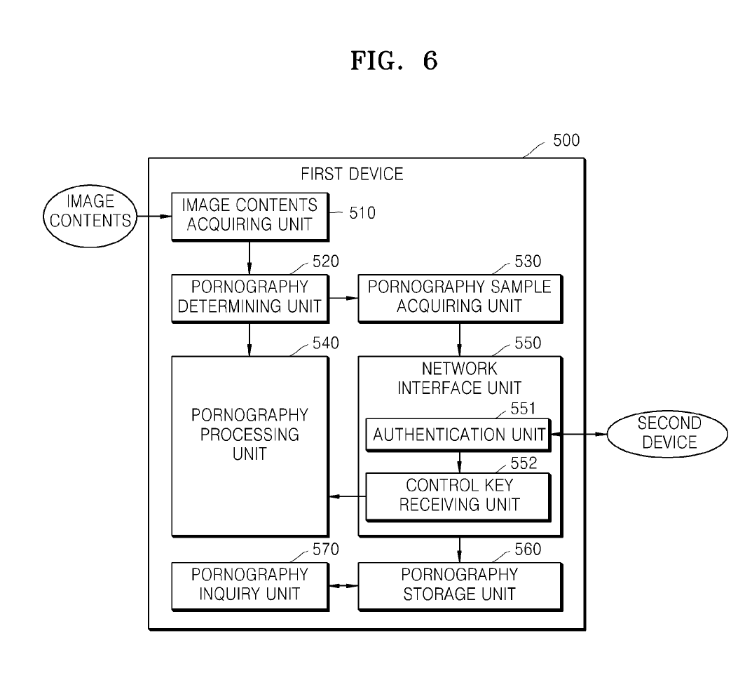

FIG. 6 is a functional block diagram of an apparatus for remotely controlling access to pornographic content of an image, according to another exemplary embodiment.

Referring to FIG. 6, the apparatus 500 may further include a pornography storage unit 560 and a pornography inquiry unit 570. The network interface unit 550 may further include an authentication unit 551 and a control key receiving unit 552.

In the pornography storage unit 560, at least one extracted representative problematic image frame may be stored. The pornography inquiry unit 570 allows a user having authority to retrieve the stored representative problematic image frame to inquire about the representative problematic image frame. According to the exemplary embodiment, if it is determined that the content of the image is pornographic, the representative problematic image frame from the content of the image is transmitted to a parent-controlled mobile device. However, due to a technical problem that may occur in a communication network, an MMS message may not be transmitted or received, or remote control may not be performed. In this situation, the representative problematic image frame may be stored, and details of the stored representative problematic image frame are stored as pornography viewing history according to time. Subsequently, a parent returning home that has authority to retrieve the stored representative problematic image frame may inquire about a child's pornography viewing history through the pornography inquiry unit 570.

The network interface unit 550 may further include the authentication unit 551, which mutually authenticates whether a second device that transmits the control commands is an authenticated device that has been already registered in a first device. The network interface unit 550 may further include the control key receiving unit 552, which receives a decryption key or inactivation key from the second device.

As described above, in the method and apparatus for remotely controlling access to pornographic content of an image according to the described exemplary embodiments, by introducing technology for detecting pornography that alleviates a parental burden of continuously monitoring his/her child, a problem of erroneously blocking content of an image file due to a false alarm may be solved by immediate parental intervention and response, which is possible regardless of the location of the child viewing pornography or the location of the parent who wishes to monitor the content being displayed on a child's device.

In addition, a child's playback and distribution of pornography are initially prevented by automatically detecting pornography when a child has captured or acquired pornography via a mobile device, thereby reducing problems due to pornographic UCC, such as pornographic still images and moving images, which numbers thereof have been rapidly increased recently.

Exemplary embodiments can also be embodied as computer readable codes on a computer readable recording medium. The computer readable recording medium is any data storage device that can store data which can be thereafter read by a computer system with a processor and a memory. Examples of the computer readable recording medium include read-only memory (ROM), random-access memory (RAM), CD-ROMs, magnetic tapes, floppy disks, optical data storage devices, etc.

While the exemplary embodiments described herein have been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A method of remotely controlling access to pornographic content of an image in a first device, the method comprising:
acquiring content of at least one image;
determining whether the content of the at least one image is pornographic by analyzing at least one image frame constituting the content of the image;
blocking access to the content of the at least one image when the content is determined to be pornographic;
copying at least one representative problematic image frame from the content of the image;
transmitting the at least one representative problematic image frame to a second device;
receiving control commands from the second device; and
controlling access to the content of the image blocked in the first device, based on the control commands.

2. The method of claim 1, wherein blocking of the use of the content of the image comprises encrypting the content of the image, or inactivating the content of the image based on a file system of the first device.

3. The method of claim 2, wherein receiving of the control commands from the second device comprises receiving a decryption key or an activation key permitting access to the blocked content of the image.

4. The method of claim 3, wherein controlling access to the content of the image comprises performing at least one controlling operation from among playback, storing, copying, moving, deleting and editing, on the content of the image.

5. The method of claim 4, wherein controlling access to the content of the image further comprises controlling the content of the image according to a degree of controlling when the contents of the image are used, including entire allowance, partial allowance or entire disallowance.

6. The method of claim 5, wherein controlling access to the content of the image further comprises controlling the content of the image based on a point of time when the content of the image is capable of being used, a length and a duration of the content of the image, an amount of the content of the image, a quality of the content of the image, and a medium for transmitting the content of the image.

7. The method of claim 3, wherein the copied representative problematic image frame is an image having a relatively high degree of lewdness among the problematic images that exceeds a predetermined reference value, and
wherein the degree of lewdness is determined according to the ratio of skin estimation areas that is estimated to be human skin, based on color values of pixels of the at least one problematic image frame.

8. The method of claim 1, wherein transmitting of the at least one representative problematic image frame to the second device is performed using a multimedia message service (MMS) or a mobile e-mail via which a message with the representative problematic image frame is attached.

9. The method of claim 1, wherein receiving of the control commands from the second device comprises mutually authenticating whether the second device that transmits the control commands is an authenticated device registered with the first device.

10. The method of claim 1, further comprising:
storing the at least one extracted representative problematic image frame; and
allowing an authorized user to retrieve the stored representative problematic image frame.

11. An apparatus for remotely controlling access to pornographic content of an image in a first device, the apparatus comprising:
an image content acquiring unit by which the first device receives the content of the image from;
a pornography determining unit which determines whether the content of the image is pornographic by analyzing a plurality of image frames constituting the content of the image;
a pornography processing unit which blocks access to the content of the image when the content is determined to be pornographic;
a pornography sample acquiring unit which copies at least one representative problematic image frame from the content of the image; and
a network interface unit which transmits the at least one representative problematic image frame to a second device, and which receives control commands from the second device,
wherein the pornography processing unit controls access to the content of the image blocked in the first device, based on the control commands.

12. The apparatus of claim 11, wherein the pornography processing unit encrypts the content of the image, or, based on a file system of the first device, inactivates the content of the image.

13. The apparatus of claim 12, wherein the network interface unit comprises a control key receiving unit for receiving a decryption key or an activation key of the blocked content of the image.

14. The apparatus of claim 13, wherein the pornography processing unit performs at least one controlling operation from among playback, storing, copying, moving, deleting and editing on the content of the image.

15. The apparatus of claim 14, wherein the pornography processing unit controls access to the content of the image according to a degree of controlling when the contents of the image are used, including entire allowance, partial allowance or entire disallowance.

16. The apparatus of claim 15, wherein the pornography processing unit controls access to the content of the image, based on a point of time when the content of the image are capable of being used, a length and a duration of the content of the image, an amount of the content of the image, a quality of the content of the image, and a medium for transmitting the content of the image.

17. The apparatus of claim 11, wherein the extracted representative problematic image frame is an image having a relatively high degree of lewdness among problematic images that exceeds a predetermined reference value, and
wherein the degree of lewdness is determined according to the ratio of skin estimation areas that is estimated to be human skin, based on color values of pixels of the at least one image frame.

18. The apparatus of claim 11, wherein the network interface unit uses a multimedia message service (MMS) or a mobile e-mail to transmit a message with the representative problematic image frame attached.

19. The apparatus of claim 11, wherein the network interface unit comprises an authentication unit for mutually authenticating whether the second device that transmits the control commands is an authenticated device registered with the first device.

20. The apparatus of claim 11, further comprising:
an image storage unit in which the at least one extracted representative problematic image frame is stored; and
an image inquiry unit which allows an authorized user to retrieve the stored representative problematic image frame.

21. A computer program product for remotely controlling access to pornographic content of an image, the computer program product embodied on a computer readable recording medium and when executed by a computer, performs a method comprising:
acquiring content of at least one image;
determining whether the content of the at least one image is pornographic by analyzing at least one image frame constituting the content of the image;
blocking access to the content of the at least one image when the content is determined to be pornographic;
copying at least one representative problematic image frame from the content of the image;
transmitting the at least one representative problematic image frame to a second device;
receiving control commands from the second device; and
controlling access to the content of the image blocked in the first device, based on the control commands.

22. A method for remote blocking of content of an image, the method comprising:
identifying inappropriate content in an image on a first device;
transmitting a portion of the inappropriate content to a second device;
receiving commands from the second device indicating whether the inappropriate content may be displayed on the first device.
